(19) United States
(12) Patent Application Publication
(10) Pub. No.: US 2015/0076398 A1
(43) Pub. Date: Mar. 19, 2015

(54) Bioremediation of soil and groundwater

(71) Applicant: John Archibald, Grimsby (CA)

(72) Inventor: John Archibald, Grimsby (CA)

(21) Appl. No.: 13/987,906

(22) Filed: Sep. 16, 2013

(51) Int. Cl. C02F 3/28; B09C 1/10; B09C 1/00

(52) U.S. Cl. CPC C02F 3/2866; B09C 1/002; B09C 1/10; C02F 2103/06
USPC 252/180; 210/610; 405/128.5

(57) ABSTRACT

A formulation for the bioremediation of soil or groundwater includes from about 80 to 95% of an emulsifiable C4-C22 vegetable oil selected from the group consisting of soybean oil, coconut oil, rapeseed (canola) oil, peanut oil, crambe oil, sunflower oil and combinations thereof; and from about 5 to 20% of an emulsifier selected from the group consisting of a vegetable oil derived from a C16-C20 fatty acid ester or a mixture of such esters. The efficacy of the formulation is improved by adding hydrogen-enriched water to the emulsifiable oil as a dilution fluid.

### FIELD OF THE INVENTION

This invention relates to a formulation and a method for the bioremediation of soil and groundwater.

### BACKGROUND OF THE INVENTION

Soil and groundwater contamination with man-made products and naturally occurring toxic substances presents a serious problem. Environmental contaminants must be managed to protect human health and the environment, and to restore aquifers to productive use. Typical groundwater contaminants include chlorinated halogenated straight-chain and aromatic hydrocarbons such as perchloroethene (PCE) and trichloroethene (TCE) and chlorinated phenols, perchlorate explosive materials such as aromatic nitrates, residues of energetic munitions, nitrates, acids, radionuclides and metal oxides.

Remediation of groundwater containing such contaminants can be effected using anaerobic biological degradation processes in saturated or variably saturated soils at a substantially lower cost than conventional methods. Anaerobic reducing conditions can be created by the addition of an organic substrate to an aquifer. Oxygen and other electron acceptors such as nitrates (NO₃) or sulfates (SO₄) are initially consumed in the presence of this organic substrate, which then provides a carbon source and an electron donor for reductive chlorination. Environmental engineers, contractors, scientists, consultants, regulatory personnel, and others charged with remediating contaminated groundwater have increasingly shown interest in the use of slow release electron donors in enhanced bioremediation (also referred to as biostimulation) systems for treating contaminants in groundwater. Emulsified vegetable oils have been used as carbon sources for enhanced halorespiration, which is the use of halogenated compounds as sources of energy. Halorespiration is also known as dehalorespiration and is a major form of anaerobic respiration which can play a part in microbial halogenated compound biodegradation.

Currently available electron donor compositions include an emulsified vegetable oil (EVO) containing 25 to 50% water. The composition is purchased from a supplier and shipped to a contamination site. Typical dilution ratios range from one part EVO and four parts water to one part EVO and twenty parts water. Additional chase water is often added to aid with distribution in the subsurface. The cost of electron donor may be a significant portion of the total process cost, therefore choosing an efficient and low cost electron donor is important to the efficacy and overall economics of the bioremediation process.

EVO composition providers include EOS Remediation, LLC, RNAS, Inc., Terra Systems Inc./HePURE Technologies and JRW Bioremediation, LLC. The main ingredients of the products offered by the four companies include, by weight, less than 10 percent food additives, emulsifiers, preservatives and 4 percent of a soluble substrate such as sodium or potassium lactate or lactic acid, with the balance being water.

The JRW composition (see U.S. Pat. No. 7,785,468) is a soy-based, self-emulsifying water-in-oil (W/O) substrate, the main ingredients of which are 45 percent soy-based oleaginous material, 35 percent ethyl acetate and 20 percent water. Other patents describing EVO compositions include U.S. Pat. No. 5,265,674 (Fredrickson et al), U.S. RE 40,448 and RE 40,734 (Borden et al) and U.S. Pat. No. 6,806,078 (Newman).

### SUMMARY OF THE INVENTION

The present invention provides a formulation and a method of in situ soil or groundwater remediation containing contaminants such as halogenated straight-chain or aromatic hydrocarbons, perchlorates, explosives such as aromatic nitrates, energetic munitions residues, acids, radionuclides or oxidized metals in which a water emulsifiable vegetable oil such as corn, soybean, canola, sunflower or olive oil is added to contaminated soil or an aquifer as an electron donor. Preferably, the efficacy of the formulation is improved by adding hydrogen-enriched water, cometabolism enhancing gas substrate-enriched water or carbon dioxide supersaturated water. The use of hydrogen-enriched water can reduce the demand for the electron donor over the life of a remediation project by as much as 50 percent. The dissolved gas enriched water is added to the emulsifiable oil as a dilution fluid, used as recirculation water or used as preconditioning water to transport injectable microorganism cultures during bioaugmentation.

The formulation is an isotropic mixture of vegetable oil and emulsifiers that have a unique ability of forming fine oil-in-water (O/W) emulsions when mixed with aqueous media under mild agitation. Spontaneous emulsification to produce a fine O/W emulsion under gentle agitation followed by dilution in aqueous media occurs since the entropy change favoring dispersion is larger than the energy needed to increase the surface area of dispersion. Emulsification occurs spontaneously due to the relatively low positive or negative free energy required to form the emulsion.

### DETAILED DESCRIPTION OF THE INVENTION

In greater detail, the formulation of the present invention includes from about 80 to 95% of an emulsifiable C4-C22 vegetable oil selected from the group consisting of soybean oil, coconut oil, rapeseed (canola) oil, peanut oil, crambe oil, sunflower oil and combinations thereof; and from about 5 to 20% of an emulsifier consisting of a vegetable oil derived from a C16-C20 fatty acid ester or mixtures of the esters.

The method of the present invention includes the step of adding water to the formulation and injecting the spontaneously formed fine O/W emulsion into the soil or groundwater. A diluted mixture of 6% formulation to 94% water is a typical injection blend. However, the blend may vary from 1% to 50% formulation and the balance water. Once the blend is injected into the subsurface, additional water (commonly referred to as chase water) can be injected to spread the initially injected liquid further into an aquifer. A chase water source can be naturally occurring groundwater. A groundwater recirculating system is formed when groundwater is extracted and re-injected as chase water. The aquifer must yield a sufficient volume of extracted groundwater during the programmed operation period for this system to perform properly. Supplied potable water can be another source of chase water.

The addition of hydrogen-enriched water to the formulation enhances the performance of in situ bioremediation of groundwater which relies on microorganisms (mainly, soil bacteria). On a mass basis, 1 gram of molecular hydrogen is sufficient to dechlorinate 20.6 grams of perchloroethene (PCE), 21.7 grams of trichloroethene (TCE), 24.0 grams of dichloroethene (DCE) or 31 grams of polyvinyl chloride (PVC) to yield ethene, assuming 100 percent utilization of the molecular hydrogen by the dechlorinating microorganisms.

Competing electron acceptors may also be dissolved in the groundwater or present as solids. One gram of molecular hydrogen is sufficient to reduce 7.9 grams of oxygen, 10.2 grams of nitrates, 55.9 grams of Fe (III) to Fe (II), 27.5 grams of Mn (IV) to Mn (III), 10.6 grams of SO₄ or 5.5 grams of CO₂. The addition of hydrogen-enriched water can reduce the demand for the organic substrate (vegetable oil) by as much as 50 percent depending upon site conditions, therefore minimizing secondary water quality issues as well as adverse changes to the aquifer's pH. Hydrogen-enriched water can also be used to precondition the carrier for culture injection in a bioaugmentation process. Hydrogen-enriched water typically contains hydrogen concentrations of 1-2 ppm. When the hydrogen-enriched water disperses throughout the adjacent aquifer it creates a treatment zone that enhances bioremediation.

The addition of water supersaturated with carbon dioxide is an alternative that further enhances performance. The injection of chase water containing dissolved carbon dioxide gas at a partial pressure higher than the partial pressure of carbon dioxide gas dissolved in groundwater following injection of the emulsifiable oil electron donor improves distribution of the oil in the ground. Moreover, CO₂ bubbles help desorb contaminants from the soil making them available for groundwater bioremediation.

In addition to dehalorespiration, other metabolic processes can be taken advantage of during groundwater remediation. For example, cometabolic bioremediation is a process in which a contaminant is degraded by an enzyme or cofactor produced during microbial metabolizing of another compound. Various aliphatic and aromatic compounds such as methane and propane function as substrates for cometabolic treatment. The aerobic cometabolic biodegraders of certain contaminants are dependent upon oxygenases, e.g. methane monooxygenase (MMO), tolune dioxygenase, tolune monooxygenase and ammonium monooxygenase. These enzymes are extremely strong oxidizers, e.g., methane monooxygenase is known to degrade more than 300 different compounds.

The treatment of contaminants with water-soluble oil as the electron donor can be further enhanced with the addition of cometabolism enhancing gas substrate-enriched water immediately downgradient of the water-soluble oil treatment zone. Cometabolic bioremediation is a remediation strategy generally aimed to stimulate biodegradation of the contaminants at concentrations that are too low to serve as a primary source of carbon or energy to biodegraders. Because cometabolic bioremediation is a strategy that allows microorganisms to fortuitously degrade contaminants, it has the advantage of reducing environmental contaminants to undetectable concentrations, e.g. <parts per trillion. (Hazen 2009, Cometabolic Bioremediation, T. C. Hazen, Lawrence Berkeley National Laboratory, Berkeley, Calif., USA which is available online.)

1. A formulation for the bioremediation of soil and groundwater that spontaneously emulsifies upon addition of aqueous media to produce an oil in water emulsion comprising from about 80 to 95% of an emulsifiable C4-C22 vegetable oil and from about 5 to 20% of an emulsifier.

2. The formulation of claim 1, wherein the vegetable oil is selected from the group consisting of soybean oil, coconut oil, rapeseed oil, peanut oil, crambe oil, sunflower oil and combinations thereof.

3. The formulation of claim 1, wherein the emulsifier is vegetable oil derived from a C16-C20 fatty acid ester or a mixture of C16-C20 fatty acid esters.

4. The formulation of claim 2, wherein the emulsifier is a vegetable oil derived from a C16-C20 fatty acid ester or a mixture of C16-C20 fatty acid esters.

5. The formulation of claim 3, wherein the fatty acid ester is selected from the group consisting of a palmitic, palmitoleic, stearic, oleic, linoleic, linolenic and arachidic esters.

6. The formulation of claim 4, wherein the fatty acid ester is selected from the group consisting of a palmitic, palmitoleic, stearic, oleic, linoleic, linolenic and arachidic esters.

7. The formulation of claim 1, further comprising water enriched with 1-2 parts per million hydrogen as a diluent fluid for the formulation.

8. A method of soil or groundwater remediation comprising the step of injecting a formulation consisting of about 80 to 95% of an emulsifiable C4-C22 vegetable oil and from about 5 to 20% of an emulsifier into the soil or groundwater.

9. The method of claim 8, wherein the vegetable oil is selected from the group consisting of soybean oil, coconut oil, rapeseed oil, peanut oil, crambe oil, sunflower oil and combinations thereof.

10. The method of claim 8, wherein the emulsifier is a vegetable oil derived from a C16-C20 fatty acid ester or a mixture of C16-C20 fatty acid esters.

11. The method of claim 9, wherein the emulsifier is a vegetable oil derived from a C16-C20 fatty acid ester or a mixture of C16-C20 fatty acid esters.

12. The method of claim 8, further comprising the step of preparing a mixture of 1-50% by volume formulation and 50-99% by volume water; and injecting the mixture into the soil or groundwater.

13. The method of claim 8, further comprising the step of mixing water enriched with 1-2 ppm hydrogen to the formulation as a diluent.

14. The method of claim 12, wherein the water is enriched with 1-2 ppm hydrogen before being mixed with the formulation.

15. The method of claim 8, further comprising the step of preparing a mixture of 6% by volume formulation and 94% by volume water, and injecting the mixture into the soil or groundwater.

16. The method of claim 13, further comprising the step of preparing a mixture of 6% by volume formulation and 94% by volume water, and injecting the mixture into the soil or groundwater.
